(19) United States
(12) Patent Application Publication
(10) Pub. No.: US 2025/0082026 A1
(43) Pub. Date: Mar. 13, 2025

(54) POWER-SUPPLY MODE SWITCHING CIRCUIT AND AEROSOL GENERATING DEVICE

(71) Applicant: SHENZHEN WOODY VAPES TECHNOLOGY CO., LTD., Shenzhen (CN)

(72) Inventors: Hong SHANG, Shenzhen (CN); Tao ZHANG, Shenzhen (CN); Yong ZHOU, Shenzhen (CN); Yanming NIU, Shenzhen (CN); Lingzhi XIAO, Shenzhen (CN); Shuangliang KUANG, Shenzhen (CN); Dan ZHU, Shenzhen (CN); Hua FANG, Shenzhen (CN); Yalei TIAN, Shenzhen (CN); Weinan JIANG, Shenzhen (CN); Zhipeng HU, Shenzhen (CN)

(73) Assignee: SHENZHEN WOODY VAPES TECHNOLOGY CO., LTD., Shenzhen (CN)

(21) Appl. No.: 18/666,268

(22) Filed: May 16, 2024

(30) Foreign Application Priority Data
Sep. 11, 2023 (CN) 202311170046.3

(51) Int. Cl. A24F 40/46; A24F 40/50; A24F 40/90; H02J 7/00

(52) U.S. Cl. CPC A24F 40/46; A24F 40/50; A24F 40/90; H02J 7/0068; H02J 7/007

(57) ABSTRACT

A power-supply mode switching circuit and an aerosol generating device are provided. The power-supply mode switching circuit includes an external-power-source power-supply circuit, a protection circuit, and a battery power-supply circuit. A node where the external-power-source power-supply circuit is connected to the protection circuit serves as a power-source input end. A node where the external-power-source power-supply circuit is connected to the battery power-supply circuit serves as a power supply end. The protection circuit is configured to control the battery power-supply circuit to be cut off when the power-source input end is connected to the external power source, to make the external power source supply power to the power supply end. The protection circuit is further configured to control the battery power-supply circuit to be conducted when the power-source input end is not connected to the external power source, to make the battery supply power to the power supply end.

### CROSS-REFERENCE TO RELATED APPLICATIONS

This application claims priority under 35 U.S.C. § 119 (a) to Chinese Patent Application No. 202311170046.3, filed Sep. 11, 2023, the entire disclosure of which is incorporated herein by reference.

### TECHNICAL FIELD

This disclosure relates to the field of aerosol-generating-device technology, and in particular to a power-supply mode switching circuit and an aerosol generating device.

### BACKGROUND

At present, aerosol generating devices are mainly powered by rechargeable batteries. When the aerosol generating devices are in use, there are three power supply scenarios: (1) powered by using an external power source alone; (2) powered by using an internal battery alone; and (3) powered by using both the external power source and the internal battery. However, in these three power supply scenarios, when the external power source is used to supply power alone, if no protection measure is taken, a direct current source will be directly pumped into the battery without passing through a charging management circuit, resulting in a fire or explosion of the battery. When the internal battery is used to supply power alone, if the direct current source at an external-power-source inlet is not isolated, a battery power source may be input into the external-power-source inlet. Therefore, for an aerosol generating device having a charging management circuit or a charging management system, a charging display function may be triggered by mistake, resulting in showing that the system is charging and giving a wrong prompt. When the external power source and the battery are both used to supply power, the battery also starts to discharge when there is additional power supply, which is not conducive to battery life when there is no power supply from the external power source. In addition, when a single-chip microcomputer (SCM) in the aerosol generating device needs to be powered and only the internal battery is used to supply power alone, if the battery voltage is too low, the SCM is insufficiently powered. The SCM is constantly and automatically started up and reset under insufficient power, so that the battery is excessively discharged due to constant reset of the SCM, and the SCM is unable to be started up to provide a charging enable signal to trigger the charging management circuit or the charging management system to charge. As a result, the battery is unable to be charged, leading to permanent damage.

### SUMMARY

In a first aspect, a power-supply mode switching circuit is provided in embodiments of the present disclosure, and is applied to an aerosol generating device. The power-supply mode switching circuit includes an external-power-source power-supply circuit, a protection circuit, and a battery power-supply circuit. The external-power-source power-supply circuit is connected to the protection circuit and the battery power-supply circuit. The protection circuit is connected to the battery power-supply circuit. The battery power-supply circuit is configured to be connected to a battery in the aerosol generating device. A node where the external-power-source power-supply circuit is connected to the protection circuit serves as a power-source input end. A node where the external-power-source power-supply circuit is connected to the battery power-supply circuit serves as a power supply end. The power-source input end is configured to be connected to an external power source. The protection circuit is configured to control the battery power-supply circuit to be cut off when the power-source input end is connected to the external power source, to make the external power source supply power to the power supply end through the external-power-source power-supply circuit. The protection circuit is further configured to control the battery power-supply circuit to be conducted when the power-source input end is not connected to the external power source, to make the battery supply power to the power supply end through the battery power-supply circuit.

In a second aspect, an aerosol generating device is further provided in embodiments of the present disclosure. The aerosol generating device includes a power-supply mode switching circuit. The power-supply mode switching circuit includes an external-power-source power-supply circuit, a protection circuit, and a battery power-supply circuit. The external-power-source power-supply circuit is connected to the protection circuit and the battery power-supply circuit. The protection circuit is connected to the battery power-supply circuit. The battery power-supply circuit is connected to a battery in the aerosol generating device. A node where the external-power-source power-supply circuit is connected to the protection circuit serves as a power-source input end. A node where the external-power-source power-supply circuit is connected to the battery power-supply circuit serves as a power supply end. The power-source input end is configured to be connected to an external power source. The protection circuit is configured to control the battery power-supply circuit to be cut off when the power-source input end is connected to the external power source, to make the external power source supply power to the power supply end through the external-power-source power-supply circuit. The protection circuit is further configured to control the battery power-supply circuit to be conducted when the power-source input end is not connected to the external power source, to make the battery supply power to the power supply end through the battery power-supply circuit.

### BRIEF DESCRIPTION OF THE DRAWINGS

To describe the technical solutions in embodiments of the present disclosure more clearly, the accompanying drawings for use in the description of embodiments are briefly described below. Apparently, the accompanying drawings in the following description show merely some embodiments of the present disclosure, and those of ordinary skill in the art may obtain other accompanying drawings from these accompanying drawings without creative effort.

FIG. 1 is a schematic block diagram of a power-supply mode switching circuit provided in an embodiment of the present disclosure.

FIG. 2 is a schematic block diagram of a power-supply mode switching circuit provided in another embodiment of the present disclosure.

FIG. 3 is a circuit diagram of a power-supply mode switching circuit provided in an embodiment of the present disclosure.

FIG. 4 is a circuit diagram of a direct current-direct current (DC-DC) conversion circuit provided in an embodiment of the present disclosure.

Reference signs in the accompanying drawings are described as follows: 10—external-power-source power-supply circuit; 11—protection circuit; 12—battery power-supply circuit; 13—DC-DC conversion circuit.

### DETAILED DESCRIPTION

Technical solutions of embodiments of the present disclosure will be described clearly and completely below with reference to accompanying drawings in embodiments of the present disclosure. Apparently, embodiments described herein are merely some embodiments, rather than all embodiments, of the present disclosure. Based on embodiments of the present disclosure, all other embodiments obtained by those of ordinary skill in the art without creative effort shall fall within the protection scope of the present disclosure.

It may be understood that terms “include”, “comprise”, and “have” as well as variations thereof used in the specification and the claims of the present disclosure are intended to indicate the presence of described features, wholes, steps, operations, elements, and/or components, but do not exclude the presence or addition of one or more other features, wholes, steps, operations, elements, components, and/or combinations thereof.

It may also be understood that the terms used in the specification of the present disclosure are merely for the purpose of describing particular embodiments and are not intended to limit the present disclosure. As used in the specification and the claims of the present disclosure, unless the context clearly indicates otherwise, the terms “a/an”, “one” and “the” in a singular form may also include a plural form.

It may be further understood that the term “and/or” used in the specification and the claims of the present disclosure refers to any and all possible combinations of one or more of the associated listed items and includes these combinations.

For any one of the resistors or capacitors mentioned in embodiments of the present disclosure, if the resistor or the capacitor is horizontally arranged in a circuit diagram, there are a first end of the resistor or the capacitor and a second end of the resistor or the capacitor from left to right in sequence; and if the resistor or the capacitor is arranged perpendicular to the horizontal direction in the circuit diagram, there are the first end of the resistor or the capacitor and the second end of the resistor or the capacitor from top to bottom in sequence.

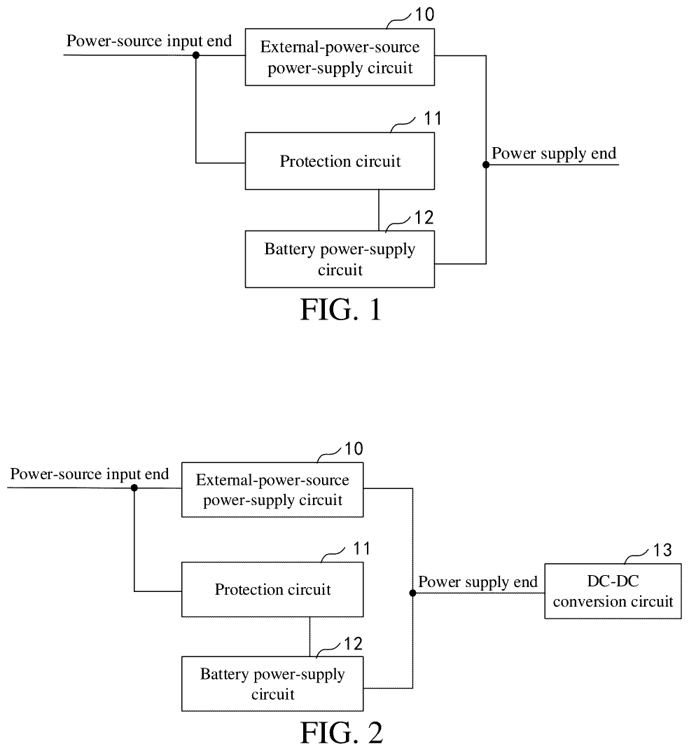

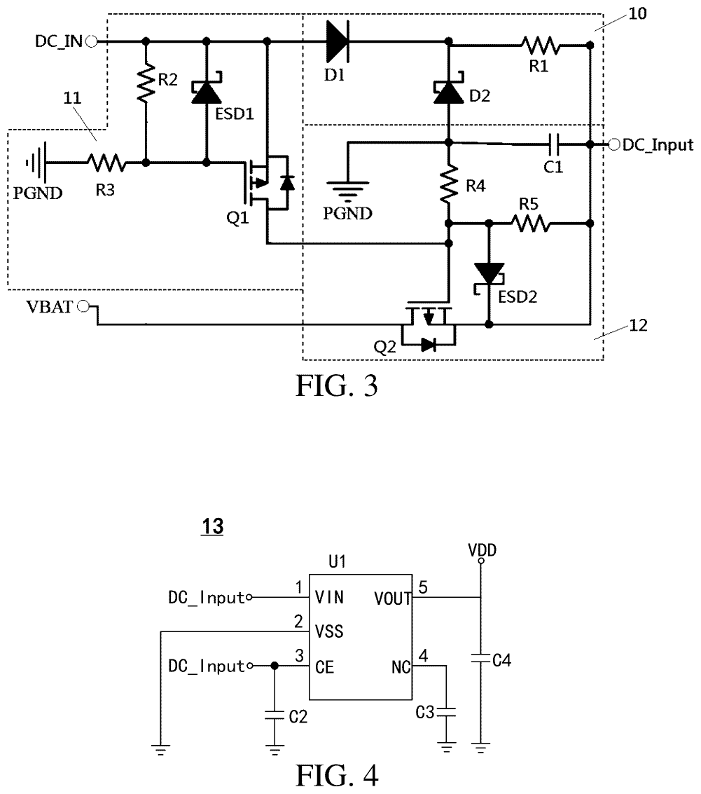

Reference can be made to FIG. 1 to FIG. 4, where FIG. 1 is a schematic block diagram of a power-supply mode switching circuit provided in an embodiment of the present disclosure, FIG. 2 is a schematic block diagram of a power-supply mode switching circuit provided in another embodiment of the present disclosure, FIG. 3 is a circuit diagram of a power-supply mode switching circuit provided in an embodiment of the present disclosure, and FIG. 4 is a circuit diagram of a direct current-direct current (DC-DC) conversion circuit provided in an embodiment of the present disclosure.

Referring to FIG. 1, a power-supply mode switching circuit is provided in an embodiment of the present disclosure, and is applied to an aerosol generating device. The power-supply mode switching circuit includes an external-power-source power-supply circuit 10, a protection circuit 11, and a battery power-supply circuit 12. The external-power-source power-supply circuit 10 is connected to the protection circuit 11 and the battery power-supply circuit 12. The protection circuit 11 is connected to the battery power-supply circuit 12. The battery power-supply circuit 12 is configured to be connected to a battery in the aerosol generating device. A node where the external-power-source power-supply circuit 10 is connected to the protection circuit 11 serves as a power-source input end. A node where the external-power-source power-supply circuit 10 is connected to the battery power-supply circuit 12 serves as a power supply end. The power-source input end is configured to be connected to an external power source. The protection circuit 11 is configured to control the battery power-supply circuit 12 to be cut off when the power-source input end is connected to the external power source, to make the external power source supply power to the power supply end through the external-power-source power-supply circuit 10. The protection circuit 11 is further configured to control the battery power-supply circuit 12 to be conducted when the power-source input end is not connected to the external power source, to make the battery supply power to the power supply end through the battery power-supply circuit 12.

In this embodiment, the power-supply mode switching circuit is disposed in the aerosol generating device. The power-supply mode switching circuit includes the external-power-source power-supply circuit 10, the protection circuit 11, and the battery power-supply circuit 12. The node where the external-power-source power-supply circuit 10 is connected to the protection circuit 11 serves as the power-source input end. The power-source input end is connected to a power-source interface in the aerosol generating device, where the power-source interface is for being connected to the external power source. In addition, the node where the external-power-source power-supply circuit 10 is connected to the battery power-supply circuit 12 serves as the power supply end. The power supply end is configured to supply power to an electronic system in the aerosol generating device. Specifically, when the power-source interface is connected to the external power source, that is, when the power-source input end is connected to the external power source, the external power source is output to the power supply end through the external-power-source power-supply circuit 10 to supply power to the electronic system, and the battery power-supply circuit 12 is cut off under the control of the protection circuit 11 to block the battery from supplying power to the electronic system. Therefore, the electronic system is powered by the external power source alone, that is, an external-power-source power-supply mode is switched to. In addition, the battery power-supply circuit 12 is cut off to prevent the external power source from directly pumping into the battery, thereby avoiding battery from fire or explosion. When the power-source interface is not connected to the external power source, that is, when the power-source input end is not connected to the external power source, the battery power-supply circuit 12 is conducted under the control of the protection circuit 11, the battery power-supply circuit 12 starts to operate, and the battery power source is output to the power supply end through the battery power-supply circuit 12 to supply power to the electronic system. Therefore, the electronic system is powered by the battery alone, that is, a battery power-supply mode is switched to. Meanwhile, the connection between the battery and the power-source input end is blocked by the external-power-source power-supply circuit 10, thereby preventing a charging management circuit from being triggered by mistake due to the input of the battery power source to the power-source interface, and avoiding wrong charging prompt.

When the power-source input end is connected to the external power source, the power-supply mode switching circuit can preferentially use the external power source to supply power to the electronic system alone, and can block the battery from supplying power to the electronic system. Therefore, when the voltage of the battery is too low, repeated reset of the SCM in the electronic system caused by the battery supplying power will not occur, so that the battery power will not be consumed, and the SCM is able to start up. The fault of the charging management system triggered by a charging enable signal provided by the SCM can be avoided. With the aid of the external-power-source power-supply circuit 10, the electronic system can be effectively powered, and normal operation of the SCM can be ensured. In addition, the charging enable signal can be provided for the charging management system controlled by the SCM, thereby ensuring that the battery can be charged, and avoiding damage or permanent damage to the battery due to abnormal charging caused by excessive discharging of the battery. Meanwhile, with the aid of the power-supply mode switching circuit, the battery can be avoided from discharging when the external power source supplies power, thereby not affecting the endurance capability of the battery when no external power source is connected.

In a more specific embodiment, referring to FIG. 2, the power-supply mode switching circuit provided in this embodiment of the present disclosure further includes a DC-DC conversion circuit 13. The DC-DC conversion circuit 13 is connected to the power supply end. The DC-DC conversion circuit 13 is configured to convert a voltage of the power supply end into an operation voltage of the SCM in the aerosol generating device.

In this embodiment, the power-supply mode switching circuit further includes the DC-DC conversion circuit 13. An input end of the DC-DC conversion circuit 13 is connected to the power supply end. An output end of the DC-DC conversion circuit 13 is configured to be connected to the SCM in the aerosol generating device. The SCM is a control unit of the aerosol generating device. The DC-DC conversion circuit 13 is configured to convert the voltage of the power supply end into the operation voltage of the SCM, to facilitate the normal operation of the SCM.

In a more specific embodiment, referring to FIG. 3, the external-power-source power-supply circuit 10 includes a Schottky diode D1, a transient suppression diode D2, and a first resistor R1. An anode of the Schottky diode D1 is connected to the protection circuit 11. A cathode of the Schottky diode D1 is connected to a cathode of the transient suppression diode D2 and a first end of the first resistor R1. An anode of the transient suppression diode D2 is grounded. A second end of the first resistor R1 is connected to the battery power-supply circuit 12.

In this embodiment, the external-power-source power-supply circuit 10 includes the Schottky diode D1, the transient suppression diode D2, and the first resistor R1. A node where the anode of the Schottky diode D1 is connected to the protection circuit 11 serves as the power-source input end (i.e., DC_IN shown in FIG. 3). When the power-source input end is connected to the external power source, the external power source reaches the power supply end (i.e., DC_Input shown in FIG. 3) through the Schottky diode D1 and the first resistor R1. Meanwhile, under the control of the protection circuit 11, the battery power-supply circuit 12 is cut off to block the battery from supplying power to the power supply end, and the DC-DC conversion circuit 13 is powered only by the external power source through the power supply end, so that the electronic system is powered by the external power source alone. When the power-source input end is not connected to the external power source, based on the unidirectional conductivity of the Schottky diode D1, the connection between the battery and the power-source input end is blocked, thereby preventing the charging management circuit from being triggered by mistake due to the input of the battery power source to the power-source interface, and avoiding wrong charging prompt. In addition, the first resistor R1 can prevent short circuit and suppress fluctuation. The transient suppression diode D2 can suppress a surge voltage produced instantaneously when the external power source is plugged in or unplugged, thereby avoiding damage to the back-end DC-DC conversion circuit 13.

In a more specific embodiment, referring to FIG. 3, the protection circuit 11 includes a second resistor R2, a third resistor R3, and a first p-channel metal-oxide-semiconductor (PMOS) transistor Q1. A first end of the second resistor R2 is connected to the anode of the Schottky diode D1. A second end of the second resistor R2 is grounded through the third resistor R3. A gate of the first PMOS transistor Q1 is connected to the second end of the second resistor R2. A source of the first PMOS transistor Q1 is connected to the anode of the Schottky diode D1. A drain of the first PMOS transistor Q1 is connected to the battery power-supply circuit 12. Specifically, the protection circuit 11 further includes a first electrostatic diode ESD1. An anode of the first electrostatic diode ESD1 is connected to the gate of the first PMOS transistor Q1. A cathode of the first electrostatic diode ESD1 is connected to the source of the first PMOS transistor Q1.

In this embodiment, the protection circuit 11 includes the second resistor R2, the third resistor R3, and the first PMOS transistor Q1. When the power-source input end is connected to the external power source, a voltage of the external power source is divided by the second resistor R2 and the third resistor R3. When the voltage of the external power source is denoted by Vin, a gate voltage of the first PMOS transistor Q1 is Vg=(Vin×R3)/(R2+R3), a source voltage of the first PMOS transistor Q1 is equal to Vin, and a turn-on voltage formed on the first PMOS transistor Q1 is V1=Vg−Vin, that is, the turn-on voltage V1 of the first PMOS transistor Q1 is less than 0V. Therefore, the first PMOS transistor Q1 is turned on, so that a drain voltage of the first PMOS transistor Q1 is equal to Vin. In this way, the battery power-supply circuit 12 is controlled to be cut off to block the battery from supplying power to the electronic system, so that the electronic system is powered by the external power source alone. When the power-source input end is not connected to the external power source, the drain voltage of the first PMOS transistor Q1 is approximately equal to 0V, so that the battery power-supply circuit 12 is controlled to be conducted, the battery power-supply circuit 12 starts to operate, and the electronic system is powered by the battery alone. In addition, the protection circuit 11 can further include the first electrostatic diode ESD1. The first electrostatic diode ESD1 is configured to protect the first PMOS transistor Q1 from damage.

In a more specific embodiment, referring to FIG. 3, the battery power-supply circuit 12 includes a second PMOS transistor Q2, a fourth resistor R4, and a fifth resistor R5. A drain of the second PMOS transistor Q2 is configured to be connected to the battery. A gate of the second PMOS transistor Q2 is connected to the drain of the first PMOS transistor Q1, a second end of the fourth resistor R4, and a first end of the fifth resistor R5. A first end of the fourth resistor R4 is grounded. A second end of the fifth resistor R5 and a source of the second PMOS transistor Q2 are connected to the second end of the first resistor R1. Specifically, the battery power-supply circuit 12 further includes a first capacitor C1. A first end of the first capacitor C1 is grounded. A second end of the first capacitor C1 is connected to the source of the second PMOS transistor Q2. More specifically, the battery power-supply circuit 12 further includes a second electrostatic diode ESD2. An anode of the second electrostatic diode ESD2 is connected to the gate of the second PMOS transistor Q2. A cathode of the second electrostatic diode ESD2 is connected to the source of the second PMOS transistor Q2. In other words, the first capacitor CI may be the capacitor A.

In this embodiment, the battery power-supply circuit 12 includes the second PMOS transistor Q2, the fourth resistor R4, and the fifth resistor R5. A node where the second end of the first resistor R1, the second end of the fifth resistor R5, and the source of the second PMOS transistor Q2 are connected to one another serves as the power supply end. When the power-source input end is connected to the external power source, the external power source connected thereto is a universal serial bus (USB) power source, that is, Vin is 5V. Therefore, a voltage at the power supply end is approximately Vin−0.4V=4.6V, where 0.4V is a voltage drop of the Schottky diode D1. In addition, the battery in the aerosol generating device is a lithium-ion battery, and a battery voltage VBAT is less than 4.6V. Therefore, an internal parasitic diode of the second PMOS transistor Q2 is in reverse bias and unable to be conducted. Meanwhile, the first PMOS transistor Q1 is turned on, so that the drain voltage of the first PMOS transistor Q1 is equal to Vin. In this case, a gate voltage of the second PMOS transistor Q2 is equal to Vin, a source voltage of the second PMOS transistor Q2 equals the voltage Vin at the power supply end minus 0.4V, that is, Vin−0.4V, and a turn-on voltage formed on the second PMOS transistor Q2 is Vin−(Vin−0.4V)=0.4V, that is, the turn-on voltage of the second PMOS transistor Q2 is greater than 0V. Thus, the second PMOS transistor Q2 is more reliably turned off, and the battery is blocked from supplying power to the electronic system. When the power-source input end is not connected to the external power source, the internal parasitic diode of the second PMOS transistor Q2 is turned on, and the voltage drop of the internal parasitic diode of the second PMOS transistor Q2 is 0.3V. In this case, the gate voltage of the second PMOS transistor Q2 is Vg′=[(VBAT−0.3)×R4]/(R4+R5), the source voltage of the second PMOS transistor Q2 is equal to VBAT, a turn-on voltage formed on the second PMOS transistor Q2 is V2=Vg′−VBAT, that is, the turn-on voltage V2 of the second PMOS transistor Q2 is less than 0V. Thus, the second PMOS transistor Q2 is more reliably turned on, and the electronic system is powered by the battery alone. Moreover, the battery power-supply circuit 12 may further include the first capacitor C1. One end of the first capacitor C1 is grounded, and the other end of the first capacitor C1 is connected to the power supply end. The first capacitor C1 is configured to reduce an input ripple caused by the back-end DC-DC conversion circuit 13. The battery power-supply circuit 12 may further include the second electrostatic diode ESD2. The second electrostatic diode ESD2 is configured to protect the second PMOS transistor Q2 from damage.

In a more specific embodiment, referring to FIG. 4, the DC-DC conversion circuit 13 includes a voltage stabilizing chip U1, a second capacitor C2, a third capacitor C3, and a fourth capacitor C4. A voltage input (VIN) pin of the voltage stabilizing chip U1 is connected to the power supply end. A voltage source supply (VSS) pin of the voltage stabilizing chip U1 is grounded. A chip enable (CE) pin of the voltage stabilizing chip U1 is connected to the power supply end. The CE pin of the voltage stabilizing chip U1 is further grounded through the second capacitor C2. A no-connect (NC) pin of the voltage stabilizing chip U1 is grounded through the third capacitor C3. A voltage output (VOUT) pin of the voltage stabilizing chip U1 is grounded through the fourth capacitor C4. The voltage stabilizing chip U1 is configured to output the operation voltage of the SCM through the VOUT pin of the voltage stabilizing chip U1. In other words, the second capacitor C2 may be the capacitor B, the third capacitor C3 may be the capacitor C, and the fourth capacitor C4 may be the capacitor D.

In this embodiment, the DC-DC conversion circuit 13 includes the voltage stabilizing chip U1, the second capacitor C2, the third capacitor C3, and the fourth capacitor C4. The VIN pin (i.e., the voltage input pin) of the voltage stabilizing chip U1 is connected to the power supply end. The VOUT pin (i.e., the voltage output pin) of the voltage stabilizing chip U1 is connected to the SCM. The voltage of the power supply end is converted into the operation voltage of the SCM by the voltage stabilizing chip U1. The operation voltage of the SCM in the aerosol generating device may be 3.3V, 2.5V, 1.8V, 1.2V, etc. The model of the voltage stabilizing chip U1 may be determined according to the operation voltage of the SCM. For example, when the operation voltage of the SCM is 3.3V, the model of the voltage stabilizing chip U1 may be determined as Ah5303. The model of the voltage stabilizing chip U1 is not specifically limited herein.

For the power-supply mode switching circuit disclosed in the present disclosure, the external power source can supply power alone when the external power source is connected, and the internal battery can supply power alone when the external power source is not connected. In addition, the power-supply mode switching circuit can provide protection during switch between the external-power-source power-supply mode and the battery power-supply mode. Therefore, the permanent damage caused by battery fire, wrong indication of charging, and excessive discharging of the battery is avoided.

An aerosol generating device is provided in an embodiment of the present disclosure. The aerosol generating device includes the power-supply mode switching circuit described in the foregoing embodiments.

In this embodiment, the aerosol generating device includes a main unit and an atomizer. Structures such as a battery, a SCM, a power-source interface, etc., are disposed in the main unit. The main unit is configured to supply electric energy to the atomizer. The power-supply mode switching circuit is connected to the main unit. Specifically, in the power-supply mode switching circuit, the node (i.e., the power-source input end) where the external-power-source power-supply circuit 10 is connected to the protection circuit 11 is connected to the power-source interface in the main unit, the battery power-supply circuit 12 is connected to the battery in the main unit, and the node (i.e., the power supply end) where the external-power-source power-supply circuit 10 is connected to the battery power-supply circuit 12 is connected to the SCM in the main unit.

For the aerosol generating device, when the power-source interface is connected to the external power source, the external power source can be output to the power supply end through the external-power-source power-supply circuit 10 to supply power to the electronic system, and the battery power-supply circuit 12 can be cut off under the control of the protection circuit 11 to block the battery from supplying power to the electronic system, so that the electronic system can be powered by the external power source alone. Therefore, the external power source can be prevented from directly pumping into the battery, thereby avoiding the battery from fire or explosion. The battery can be ensured to be charged to avoid damage or permanent damage to the battery due to abnormal charging caused by excessive discharging of the battery. In addition, the battery is avoided from discharging when the external power source supplies power, thereby not affecting the endurance capability of the battery when no external power source is connected. Furthermore, for the aerosol generating device, when no external power source is connected to the power source interface, the battery power-supply circuit 12 is conducted under the control of the protection circuit 11, the battery power-supply circuit 12 starts to operate, and the battery power source is output to the power supply end through the battery power-supply circuit 12 to supply power to the electronic system, so that the electronic system can be powered by the battery alone. Meanwhile, the connection between the battery and the power-source input end is blocked by the external-power-source power-supply circuit 10, thereby preventing the charging management circuit from being triggered by mistake due to the input of the battery power supply to the power-source interface, thereby avoiding wrong charging prompt.

The above are merely specific implementations of the present disclosure, but are not intended to limit the scope of protection of the present disclosure. Any equivalent modification or replacement is apparent to those skilled in the art within the technical scope disclosed in the present disclosure, and those modifications or replacements shall be within the scope of protection of the present disclosure. Therefore, the scope of protection of the present disclosure shall be subject to the scope of protection of the claims.

What is claimed is:

1. A power-supply mode switching circuit, applied to an aerosol generating device, and comprising an external-power-source power-supply circuit, a protection circuit, and a battery power-supply circuit; wherein
the external-power-source power-supply circuit is connected to the protection circuit and the battery power-supply circuit, and the protection circuit is connected to the battery power-supply circuit; and the battery power-supply circuit is configured to be connected to a battery in the aerosol generating device; and
a node where the external-power-source power-supply circuit is connected to the protection circuit serves as a power-source input end, a node where the external-power-source power-supply circuit is connected to the battery power-supply circuit serves as a power supply end, the power-source input end is configured to be connected to an external power source, and the protection circuit is configured to control the battery power-supply circuit to be cut off when the power-source input end is connected to the external power source, to make the external power source supply power to the power supply end through the external-power-source power-supply circuit; and the protection circuit is further configured to control the battery power-supply circuit to be conducted when the power-source input end is not connected to the external power source, to make the battery supply power to the power supply end through the battery power-supply circuit.

2. The power-supply mode switching circuit of claim 1, further comprising a direct current-direct current (DC-DC) conversion circuit, wherein the DC-DC conversion circuit is connected to the power supply end, and the DC-DC conversion circuit is configured to convert a voltage of the power supply end into an operation voltage of a single-chip microcomputer (SCM) in the aerosol generating device.

3. The power-supply mode switching circuit of claim 2, wherein the external-power-source power-supply circuit comprises a Schottky diode, a transient suppression diode, and a first resistor; and an anode of the Schottky diode is connected to the protection circuit, a cathode of the Schottky diode is connected to a cathode of the transient suppression diode and a first end of the first resistor, an anode of the transient suppression diode is grounded, and a second end of the first resistor is connected to the battery power-supply circuit.

4. The power-supply mode switching circuit of claim 3, wherein the protection circuit comprises a second resistor, a third resistor, and a first p-channel metal-oxide-semiconductor (PMOS) transistor; a first end of the second resistor is connected to the anode of the Schottky diode, and a second end of the second resistor is grounded through the third resistor; and a gate of the first PMOS transistor is connected to the second end of the second resistor, a source of the first PMOS transistor is connected to the anode of the Schottky diode, and a drain of the first PMOS transistor is connected to the battery power-supply circuit.

5. The power-supply mode switching circuit of claim 4, wherein the protection circuit further comprises a first electrostatic diode, an anode of the first electrostatic diode is connected to the gate of the first PMOS transistor, and a cathode of the first electrostatic diode is connected to the source of the first PMOS transistor.

6. The power-supply mode switching circuit of claim 5, wherein the battery power-supply circuit comprises a second PMOS transistor, a fourth resistor, and a fifth resistor; and a drain of the second PMOS transistor is configured to be connected to the battery, a gate of the second PMOS transistor is connected to the drain of the first PMOS transistor, a second end of the fourth resistor, and a first end of the fifth resistor, a first end of the fourth resistor is grounded, and a second end of the fifth resistor and a source of the second PMOS transistor are connected to the second end of the first resistor.

7. The power-supply mode switching circuit of claim 6, wherein the battery power-supply circuit further comprises a capacitor A, a first end of the capacitor A is grounded, and a second end of the capacitor A is connected to the source of the second PMOS transistor.

8. The power-supply mode switching circuit of claim 7, wherein the battery power-supply circuit further comprises a second electrostatic diode, an anode of the second electrostatic diode is connected to the gate of the second PMOS transistor, and a cathode of the second electrostatic diode is connected to the source of the second PMOS transistor.

9. The power-supply mode switching circuit of claim 2, wherein the DC-DC conversion circuit comprises a voltage stabilizing chip, a capacitor B, a capacitor C, and a capacitor D; a voltage input (VIN) pin of the voltage stabilizing chip is connected to the power supply end; a voltage source supply (VSS) pin of the voltage stabilizing chip is grounded; a chip enable (CE) pin of the voltage stabilizing chip is connected to the power supply end, and the CE pin of the voltage stabilizing chip is further grounded through the capacitor B; a no-connect (NC) pin of the voltage stabilizing chip is grounded through the capacitor C; and a voltage output (VOUT) pin of the voltage stabilizing chip is grounded through the capacitor D, and the voltage stabilizing chip is configured to output the operation voltage of the SCM through the VOUT pin of the voltage stabilizing chip.

10. An aerosol generating device comprising a power-supply mode switching circuit, wherein the power-supply mode switching circuit comprises an external-power-source power-supply circuit, a protection circuit, and a battery power-supply circuit; wherein
the external-power-source power-supply circuit is connected to the protection circuit and the battery power-supply circuit, and the protection circuit is connected to the battery power-supply circuit; and the battery power-supply circuit is connected to a battery in the aerosol generating device; and
a node where the external-power-source power-supply circuit is connected to the protection circuit serves as a power-source input end, a node where the external-power-source power-supply circuit is connected to the battery power-supply circuit serves as a power supply end, the power-source input end is configured to be connected to an external power source, and the protection circuit is configured to control the battery power-supply circuit to be cut off when the power-source input end is connected to the external power source, to make the external power source supply power to the power supply end through the external-power-source power-supply circuit; and the protection circuit is further configured to control the battery power-supply circuit to be conducted when the power-source input end is not connected to the external power source, to make the battery supply power to the power supply end through the battery power-supply circuit.

11. The aerosol generating device of claim 10, wherein the power-supply mode switching circuit further comprises a direct current-direct current (DC-DC) conversion circuit, the DC-DC conversion circuit is connected to the power supply end, and the DC-DC conversion circuit is configured to convert a voltage of the power supply end into an operation voltage of a single-chip microcomputer (SCM) in the aerosol generating device.

12. The aerosol generating device of claim 11, wherein the external-power-source power-supply circuit comprises a Schottky diode, a transient suppression diode, and a first resistor; and an anode of the Schottky diode is connected to the protection circuit, a cathode of the Schottky diode is connected to a cathode of the transient suppression diode and a first end of the first resistor, an anode of the transient suppression diode is grounded, and a second end of the first resistor is connected to the battery power-supply circuit.

13. The aerosol generating device of claim 12, wherein the protection circuit comprises a second resistor, a third resistor, and a first p-channel metal-oxide-semiconductor (PMOS) transistor; a first end of the second resistor is connected to the anode of the Schottky diode, and a second end of the second resistor is grounded through the third resistor; and a gate of the first PMOS transistor is connected to the second end of the second resistor, a source of the first PMOS transistor is connected to the anode of the Schottky diode, and a drain of the first PMOS transistor is connected to the battery power-supply circuit.

14. The aerosol generating device of claim 13, wherein the protection circuit further comprises a first electrostatic diode, an anode of the first electrostatic diode is connected to the gate of the first PMOS transistor, and a cathode of the first electrostatic diode is connected to the source of the first PMOS transistor.

15. The aerosol generating device of claim 14, wherein the battery power-supply circuit comprises a second PMOS transistor, a fourth resistor, and a fifth resistor; and a drain of the second PMOS transistor is connected to the battery, a gate of the second PMOS transistor is connected to the drain of the first PMOS transistor, a second end of the fourth resistor, and a first end of the fifth resistor, a first end of the fourth resistor is grounded, and a second end of the fifth resistor and a source of the second PMOS transistor are connected to the second end of the first resistor.

16. The aerosol generating device of claim 15, wherein the battery power-supply circuit further comprises a capacitor A, a first end of the capacitor A is grounded, and a second end of the capacitor A is connected to the source of the second PMOS transistor.

17. The aerosol generating device of claim 16, wherein the battery power-supply circuit further comprises a second electrostatic diode, an anode of the second electrostatic diode is connected to the gate of the second PMOS transistor, and a cathode of the second electrostatic diode is connected to the source of the second PMOS transistor.

18. The aerosol generating device of claim 11, wherein the DC-DC conversion circuit comprises a voltage stabilizing chip, a capacitor B, a capacitor C, and a capacitor D; a voltage input (VIN) pin of the voltage stabilizing chip is connected to the power supply end; a voltage source supply (VSS) pin of the voltage stabilizing chip is grounded; a chip enable (CE) pin of the voltage stabilizing chip is connected to the power supply end, and the CE pin of the voltage stabilizing chip is further grounded through the capacitor B; a no-connect (NC) pin of the voltage stabilizing chip is grounded through the capacitor C; and a voltage output (VOUT) pin of the voltage stabilizing chip is grounded through the capacitor D, and the voltage stabilizing chip is configured to output the operation voltage of the SCM through the VOUT pin of the voltage stabilizing chip.
